(19) United States
(12) Patent Application Publication
(10) Pub. No.: US 2025/0386773 A1
(43) Pub. Date: Dec. 25, 2025

(54) CLIMATE REGULATION FOR PLANT STUDY IN OPEN-AIR FIELDS

(71) Applicant: Washington State University, Pullman, WA (US)

(72) Inventors: Jacob Blauer, Pullman, WA (US); Mark J. Pavek, Pullman, WA (US); Soumik Banerjee, Pullman, WA (US)

(21) Appl. No.: 19/231,741

(22) Filed: Jun. 9, 2025

Related U.S. Application Data
(60) Provisional application No. 63/662,401, filed on Jun. 20, 2024.

(51) Int. Cl. A01G 9/24; A01G 9/16

(52) U.S. Cl. CPC A01G 9/246; A01G 9/16

(57) ABSTRACT

The present technology is directed to climate control systems suitable for studying plant growth in open-air fields and associated methods of operation. In one example, a method includes exposing a test specimen of a crop in an open-air field to substantially the same sunlight, precipitation, and/or pestilence conditions as a control specimen in the same open-air field for a test period. The test specimen is at least partially enclosed by a structure while the control specimen is outside of the structure. The structure has a first opening toward the soil of the open-air field and second opening exposed to ambient air. During the test period, a test temperature profile is maintained in the internal space of the structure while an air curtain is placed across the second opening of the structure to limit or prevent thermal interactions between the internal space of the structure and the ambient air.

### CROSS-REFERENCE TO RELATED APPLICATION(S)

This application claims priority to U.S. Provisional Application No. 63/662,401, filed Jun. 20, 2024, the disclosure of which is incorporated herein by reference in its entirety.

### GOVERNMENT INTERESTS

This technology has been made with government support under grant number AM22SCBPWA1153-00 awarded by the United States Department of Agriculture through the Agricultural Marketing Service. The government has certain rights in this technology.

### BACKGROUND

Climate change has been an issue for agriculture both globally and domestically. The impact of climate change on commercial food production depends on growing regions. In the Pacific Northwest (PNW), on-going research from the Blauer lab at Washington State University (Pullman, WA) has demonstrated that the mean temperature in the PNW has increased by about 0.8° C. over the past fifty years. During the 2021 production season, a heat dome hit the PNW, and in Othello, WA, temperatures were reported as high as 47.8° C. for several days. Such high temperatures were damaging to crops, especially to potatoes. Growers lacked knowledge on how best to protect crops from such extreme heat.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

As mentioned above, climate change can cause extreme weather patterns, such as extreme heat, that may negatively impact crop cultivation. For instance, heat stress in potatoes can cause yield reductions, malformed tubers, and a loss in post-harvest quality. Additionally, normal practices promoting plant growth can have negative impacts when excessive heat occurs. One example involves nutrient management. Nitrogen fertility rates under “normal” conditions can become excessive under extreme heat. In general, warm temperatures promote excessive foliar growth and even foliar senescence in plants such as potatoes. Both occurrences may result in lost production. In addition, in variety development programs, efforts are undertaken to select for germplasm that is resistant to temperature stress but testing for such traits is challenging because either the testing environment is not consistent with the actual growing environment or is difficult to reproduce or compare as in multi-site testing.

Research has been conducted to investigate heat stress in potatoes and other crops using, for example, differential planting locations, differential planting time intervals, greenhouse facilities, infrared light heating of test plots, heat-trapping canopy structures, heat cables, and even miniature greenhouses type structures in a field to simulate warm temperatures beyond ambient. Each of the foregoing techniques have shed a degree of knowledge on plant responses to heat but with significant limitations and drawbacks. For instance, one drawback is related to interference from the test equipment on UV-solar radiation that plants need to fix carbon from the atmosphere to synthesize carbohydrates. Furthermore, heat studies that only altered soil temperature can study tuber and root heat reactions/interactions but the impact on foliage remains unknown. In addition, full canopy coverage (e.g., using greenhouses or greenhouse-like structures) alters atmospheric balances of humidity, wind, and temperature, exposure to natural solar radiation, while limiting natural environmental interactions such exposure to insects in the field and do not consistently provide temperature control with diurnal fluctuations. As such, these techniques do not allow the consistent study of the impact of a single variable (e.g., temperature) on plant growth.

Several embodiments of the disclosed technology provide a continuously operating climate control system that can address several aspects of the foregoing drawbacks. In certain embodiments, the climate control system can include a semi-enclosed structure, an air curtain unit, and/or a conditioning assembly operatively coupled to one another. The semi-enclosed structure can include one or more sidewalls that can surround a test area in an open-air field. The one or more sidewalls form a first opening proximate to the soil in the test area and a second opening opposite the first opening and exposed to the outside ambient environment. In certain embodiments, the first and second openings are of generally the same size and/or shape. In other embodiments, the first and second openings can have different sizes and/or shapes via configuration of the one or more sidewalls and/or additions of partial coverings over the first and/or second openings.

During operation, the air curtain unit can place an air curtain across the second opening and thus limit or prevent thermal interactions between the air in the internal space of the semi-enclosed structure and the outside ambient environment. With the air curtain in place, the conditioning assembly can then provide a circulation of hot/cold air to the internal space of the semi-enclosed structure to simulate temperature abnormalities with respect to the ambient. By modulating thermal input to the internal space, a target temperature profile in the test area can be achieved while the test area is subject to the same rainfall, humidity, wind, insect, or other environmental conditions as other portions of the open-air planting field. Thus, several embodiments of the disclosed technology can allow accurate study of abnormal temperature impacts on plant growth while holding other environmental variables generally constant compared to ambient conditions or controlled for the specific study target(s).

In one illustrative example, the semi-enclosed structure can include a rectangular box with an open bottom to be placed on prepared soil in a test area, an open top, and one or more sidewalls comprised of a wind-blocking material fitted with an air blower assembly configured to controllably place an air curtain across the open top. The semi-enclosed structure can also be coupled with a conditioning assembly configured to raise/lower the temperature in the internal space of the semi-enclosed structure. In some embodiments, a climate controller can be configured to cycle the air curtain and/or the conditioning assembly to maintain a continuously or intermittently raised or lowered temperature profile as compared to that of the outside ambient environment. In an alternate embodiment, the air can be circulated through piping systems with nozzles to more uniformly blow heated air across the walls of the box. In other embodiments, the semi-enclosed structure can also be coupled to additional and/or different mechanical/electrical components such as sensors, data storage units, controls mechanism, apparatus to regulate temperature settings, apparatus to record and transmit data, etc.

In one aspect, the semi-enclosed structure can be used for crop research. A test specimen of a crop of interest can be planted inside the test area surrounded by the semi-enclosed structure alongside control specimens outside the semi-enclosed structure and exposed to the ambient environment. The test specimens and the control specimens can be exposed for a period of time to substantially the same environmental conditions (e.g., sunlight, precipitation, pestilence, etc.) while a temperature profile different from the ambient is maintained for the test specimens. After a suitable period of time, a set of growth characteristics of the test and control specimens can be compared to determine any impact of temperature differences during plant growth. In other embodiments, the semi-enclosed structure can also be used to grow off-season crops or be used for other suitable purposes.

In certain applications, researchers or other suitable parties can program a test temperature profile according to study objectives. For instance, the test temperature profile can include continuously or intermittently elevated/lowered temperatures such as to correspond to daily highs, daily lows, or temperatures in proximity to precipitation/irrigation cycles. Example temperature shifts can be in the range of about 0° C. to about 10° C., about −10° C. to about 0° C., about −5° C. to about 5° C., or other suitable temperature ranges. In other applications, researchers or other suitable parties can program a test humidity profile or other suitable types of test profiles. Accordingly, the several embodiments of the disclosed technology can bring temperature-controlled studies out of greenhouses to better compare specimens exposed to most field conditions and empower high fidelity single-variable crop research of climate impacts.

### BRIEF DESCRIPTION OF THE DRAWINGS

FIG. 1 is a schematic diagram of one embodiment of a climate control system configured to regulate climate conditions suitable for studying plant growth in an open-air field in accordance with embodiments of the disclosed technology.

FIG. 2 is a schematic diagram illustrating a computer-implemented climate controller suitable for the climate control system of FIG. 1 in accordance with embodiments of the disclosed technology.

FIGS. 3A and 3B are examples of temperature profiles related to the climate control system of FIG. 1 in accordance with embodiments of the disclosed technology.

FIGS. 4A and 4B are additional examples of the climate control system of FIG. 1 in accordance with embodiments of the disclosed technology.

FIG. 5 is a flow diagram illustrating an example process of using the climate control system of FIG. 1 in accordance with embodiments of the disclosed technology.

### DETAILED DESCRIPTION

Various embodiments of climate control systems, assemblies, devices, and associated processes of operation configured to regulate environmental conditions in open-air fields are described herein. Though a study of potatoes was used as an example application for the disclosed technology, the disclosed technology has direct application for other crops and plants of commercial and ornamental interest. Such plants include, but are not limited to soybeans, alfalfa, tomatoes, strawberries, blueberries, wheat, raspberries, grapes, onions, leafy greens (lettuce), cucumbers, pumpkins, melons, peppers, egg plants, rice, green beans, peas, lentils, beans, peanuts, broccoli, cauliflower, carrots, garlic, herbs, squash, celery, sweet potatoes, grasses, flowers, trees (e.g., apple trees, etc.), etc. In the following description, specific details of examples are included to provide a thorough understanding of certain embodiments of the disclosed technology. A person skilled in the relevant art will also understand that the disclosed technology may have additional embodiments or may be practiced without several of the details of the embodiments described below with reference to FIGS. 1-5.

Extreme weather patterns, such as extreme heat or cold, can negatively impact plant growth and crop cultivation. For instance, heat stress in potatoes can cause yield reductions, malformed tubers, and a loss in post-harvest quality. Additionally, normal practices promoting plant growth, such as nitrogen fertilization, can have negative impacts when excessive heat occurs. Though various techniques, such as using heat-trapping canopy structures, have been used to investigate impact of heat stress on crops, such techniques can have certain drawbacks. For instance, heat-trapping canopy structures may interfere with UV-solar radiation. In addition, full canopy coverage can alter atmospheric balances of humidity, wind, and temperature while limiting natural environmental interactions such exposure to insects in a field. As such, these techniques do not allow the study of the impact of individual target variables (e.g., temperature) on plant growth.

Several embodiments of the disclosed technology are directed to a climate control system that can address aspects of the foregoing drawback and be suitable for studying plant growth in open-air fields. In certain examples, the climate control system can include a semi-enclosed structure to partially surround test specimens while allowing exposure of the test specimens to ambient air via an opening. The climate control system can also include a conditioning assembly configured to selectively heat/cool an internal space in the semi-enclosed structure. To improve energy efficiency of such heating/colling, the climate control system can further include an air curtain unit operatively coupled to the semi-enclosed structure. During operation, the air curtain unit can place an air curtain across the opening to limit or prevent thermal interactions between air in the internal space of semi-enclosed structure and the ambient air. As such, the test specimen can be exposed to substantially the same rainfall, humidity, wind, insect, or other environmental conditions as control specimens outside of the semi-enclosed structure. As a result, the climate control system can allow impact studies of abnormal environmental conditions, such as high/low temperatures or humidity on plant growth while holding other environmental variables generally constant in an energy efficient manner, as described in more detail below with reference to FIGS. 1-5.

FIG. 1 is a schematic diagram of a climate control system 100 configured to regulate climate conditions suitable for studying plant growth in an open-air field 101 in accordance with embodiments of the disclosed technology. As shown in FIG. 1, the open-air field 101 can include soil in which one or more test specimens 102a are growing next to control specimens 102b. In certain applications, the test specimens 102a and control specimens 102b are of the same crop, such as potatoes. In other applications, at least some of the test specimens 102a can be a different genus, species, and/or genotype of crops from the other test specimens 102a or the control specimens 102b. In further applications, the test specimens 102a and 102b can be the same species/genotype to be compared to other species/genotypes for testing response in variety development programs including, for instance, trait discovery, characterization, and/or selection.

As shown in FIG. 1, the climate control system 100 can include a semi-enclosed structure 104 that is configured to partially enclose the test specimens 102a by placing the semi-enclosed structure 104 into the soil, as represented by the arrow 103. The semi-enclosed structure 104 can include one or more sidewalls 104 suitably coupled to one another to partially enclose an internal space 109 between a first opening 107a toward the soil of the open-air field 101 and a second opening 107b exposed to ambient air. In certain embodiments, the sidewalls 106 can be constructed from a wind blocking material that is transparent, or at least partially transparent, such as tempered glass, acrylic, polycarbonate, polyvinyl chloride, or fiberglass to allow for solar radiation for plant growth. In other embodiments, at least one of the sidewalls 106 can be opaque. In further embodiments, at least one of the sidewalls 106 can be constructed from a metal mesh, perforated metal panels, or other partially wind blocking or non-wind blocking materials.

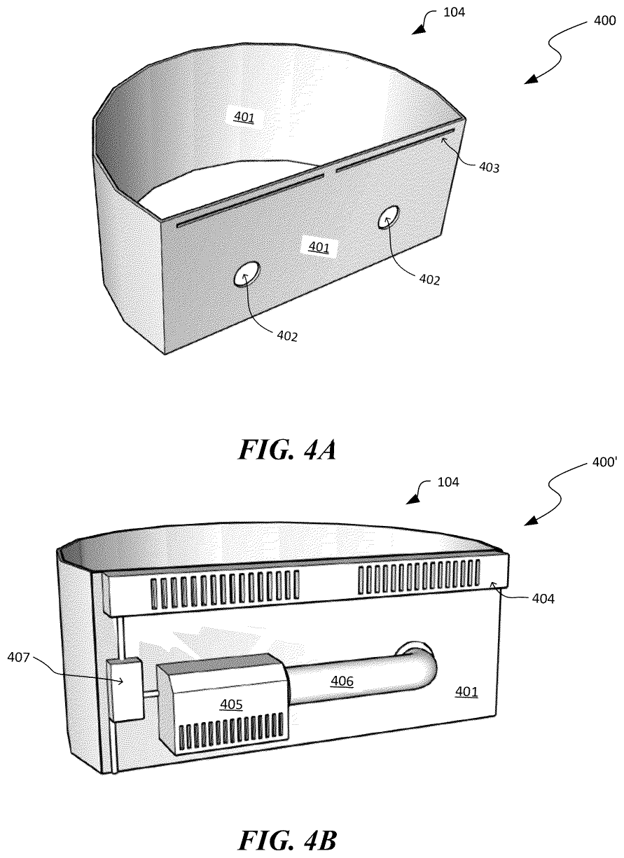

In the illustrated embodiment in FIG. 1, the semi-enclosed structure 104 includes four sidewalls (shown as first, second, third, and fourth sidewalls 106a-106d, respectively) suitably fastened together to form a generally rectangular prism. As such, both the first opening 107a and the second opening 107b have a generally rectangular cross section. In other embodiments, the semi-enclosed structure 104 can include one, two, three, five, or any other suitable numbers of sidewalls 104 interconnected to form triangular, square, oval, hexagonal, octagonal, circular, semi-circular, trapezoidal, or any other suitable shapes depending on a corresponding application. As an illustration, the semi-enclosed structure 104 having semi-circular shapes are described in more detail below with reference to FIGS. 4A and 4B.

The climate control system 100 can include an air curtain unit 112 operatively coupled to the semi-enclosed structure 104. In the illustrated embodiment, the air curtain unit 112 includes a set of air movers 113 such as fans mounted in the second sidewall 106b proximate to the second opening 107b. The set of air movers 113 can be configured to selectively place an air curtain 114 across the second opening 107b by generating air streams (as represented by the arrows 115) from outside of the semi-enclosed structure 104, across the second opening 106b, and toward the fourth sidewall 106d. As such, during operation, the air curtain 114 can limit or prevent thermal interactions between air in the internal space 109 of the semi-enclosed structure 104 and the ambient air and thus improve energy efficiency of the climate control system 100, as described in more detail below.

In certain embodiments, the semi-enclosed structure 104 can also be operatively coupled to a conditioning assembly 121 that is configured to regulate one or more climate conditions in the internal space 109. For instance, as shown in FIG. 1, the conditioning assembly 121 can include a heating/cooling element 122 (e.g., a heat pump) and a recirculation blower 124 operatively coupled to each other and to the semi-enclosed structure 104. In the illustrated embodiment, the semi-enclosed structure 104 includes an air inlet 110a on the first sidewall 106a and an air outlet 110b on the opposite third sidewall 106c. The air inlet 110a is coupled to the discharge of the recirculation blower 124 while the air outlet 110b is coupled to the inlet of the heating/cooling element 122. Such coupling can be via pipes, hoses, or other suitable components arranged in a suitable fashion, such as wrapping around the semi-enclosed structure 104. In FIG. 1, the air inlet 110a is shown offset in elevation from the air outlet 110b. In other embodiments, the air inlet 110a and the air outlet 110b can be generally level with each other or can have other suitable configurations. In other embodiments, the conditioning assembly 121 can include a water cooler, a chiller, a humidifier, a dehumidifier, soil heating cables, and/or other suitable mechanical/electrical components in addition to or in lieu of those shown in FIG. 1 to control the air and/or soil temperature in the semi-enclosed structure 104.

As shown in FIG. 1, the climate control system 100 can further include one or more sensors 116 and a climate controller 130 operatively coupled to the one or more sensors 116, the conditioning assembly 121, and the air curtain unit 112. In one example, the climate controller 130 can include a thermostat. In other examples, the climate controller 130 can include a programmable logic controller or other suitable types of logic controllers.

In the illustrated example, the sensors 116 include an internal air temperature sensor 116a located in the internal space 109 of the semi-enclosed structure 104, a ground temperature sensor 116b planted into the soil next to the test specimens 102a, an ambient ground temperature sensor 116c planted into the soil next to the control specimens 102b, and an ambient air temperature sensor 116d. The sensors 116 can include a thermocouple, a resistance temperature detector, or other suitable types of sensing elements. In other examples, the one or more sensors 116 can also include a barometric sensor, a humidity sensor, an anemometer, a pyranometer, a UV sensor, a rain gauge, a carbon dioxide sensor, a soil moisture sensor, and/or other suitable types of sensors.

The climate controller 130 can be configured to regulate one or more climate conditions in the internal space 109 of the semi-enclosed structure 104. For instance, the climate controller 130 can, based on readings from the sensors 116, selectively maintain a temperature profile of continuously or intermittently raised or lowered temperature within the internal space 109 of the semi-enclosed structure 104 as compared to the temperature of the ambient air, as described below.

In operation, the climate controller 130 can retrieve (e.g., from internal memory, not shown) and/or receive (e.g., via a WIFI connection, not shown) data representing a target temperature profile for the internal space 109. In one example, the target temperature profile indicates a target temperature for the internal space 109 that is higher than the ambient temperature. In response, the climate controller 130 can be configured to compare, for instance, the target temperature for the internal space 109 with a current reading from the internal air temperature sensor 116a. In response to determining that a discrepancy exists, the climate controller 130 can be configured to command the recirculation blower 124 and the heating/cooling element 122 to energize. In response, the recirculation blower 124 provide supply air to the semi-enclosed structure 104 via the air inlet 110a while return air from the air outlet 110b is heated by the heating/cooling element 122. The recirculation blower 124 then recirculates the heated air as supply air to the semi-enclosed structure 104. As such, continued operation of the heating/cooling element 122 and the recirculation blower 124 can thus raise the internal temperature to be at or at least within a threshold of the target temperature.

During the foregoing operation, the climate controller 130 can also command the air curtain unit 112 to place an air curtain 114 across the second opening 107b to limit or prevent thermal interaction between air in the internal space 109 of the semi-enclosed structure 104 with the ambient air. As such, energy efficiency of the heating/cooling operation can be significantly improved. Subsequently, after a testing period, growth characteristics of the test specimens 102a and the control specimens 102b can be compared to determine impact of the temperature difference on growth of the crop.

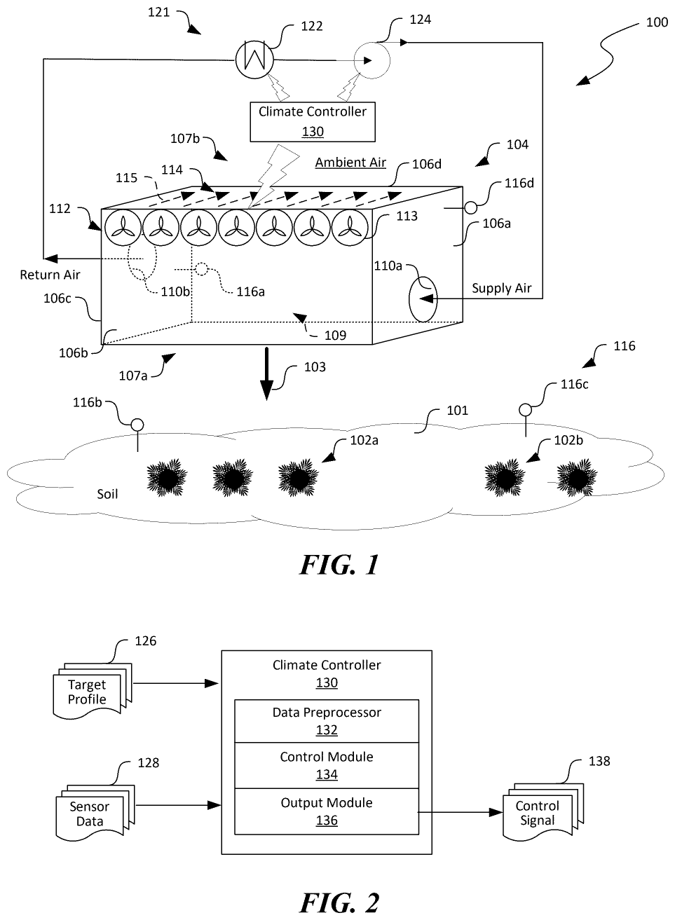

Though the temperature of the internal space 109 was used as an example to illustrate operation of the climate controller 130. In other examples, the target temperature profile can indicate target soil temperatures, target average temperature over a period, target humidity levels, or other suitable variables for studying plant growth. In further examples, the climate controller 130 can also be configured to record various process and control variables over a study period and store the recorded data in an internal memory or transmitted to a remote receiver. Example components suitable for the climate controller 130 are described below in more detail with reference to FIG. 2.

FIG. 2 is a schematic diagram illustrating a computer-implemented climate controller 130 suitable for the climate control system 100 of FIG. 1 in accordance with embodiments of the disclosed technology. In FIG. 2 and in other Figures herein, individual software components, objects, classes, modules, and routines may be a computer program, procedure, or process written as source code in C, C++, C #, Java, and/or other suitable programming languages. A component may include, without limitation, one or more modules, objects, classes, routines, properties, processes, threads, executables, libraries, or other components. Components may be in source or binary form. Components may also include aspects of source code before compilation (e.g., classes, properties, procedures, routines), compiled binary units (e.g., libraries, executables), or artifacts instantiated and used at runtime (e.g., objects, processes, threads).

Within a system, different components can have different forms. As one example, a system can comprise a first component, a second component, and a third component operatively coupled to one another. The foregoing components can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a tablet computer, a network server, a laptop computer, a smartphone, and/or other suitable computing devices.

Equally, components may include hardware circuitry. In certain examples, hardware may be considered fossilized software, and software may be considered liquefied hardware. As just one example, software instructions in a component may be burned to a Programmable Logic Array circuit or may be designed as a hardware component with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media. As used herein, the term “computer readable storage media” excludes propagated signals.

As shown in FIG. 2, the climate controller 130 can include a data preprocessor 132, a control module 134, and an output module 136 operatively coupled with one another. Though particular components are shown in FIG. 2, in other embodiments, the climate controller 130 may include additional and/or different components in addition to or in lieu of at least one of the foregoing components. For example, in certain implementations, the data preprocessor 102 may be omitted. In other implementations, the climate controller 130 may include network, storage, data handling, or other suitable types of component(s).

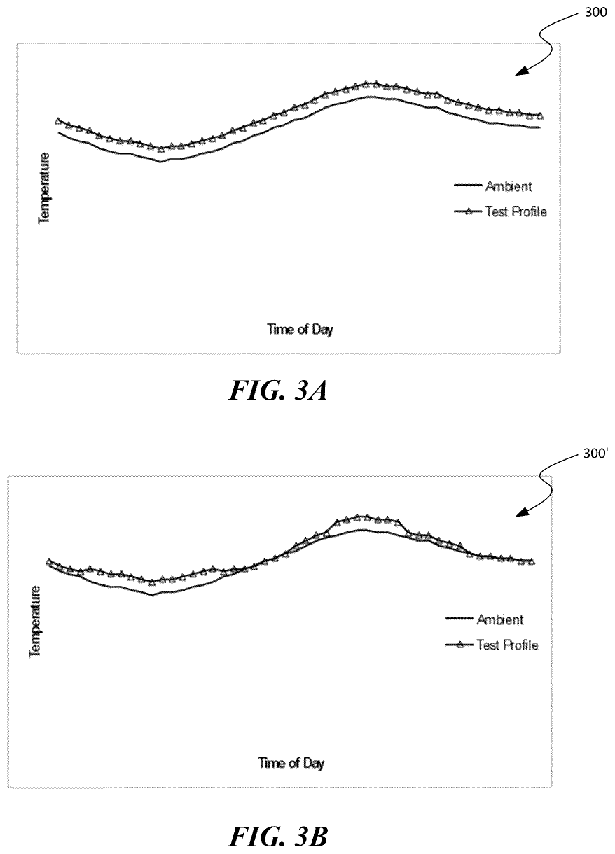

The data preprocessor 102 can be configured to receive data representing a target profile 126. The data of the target profile 126 can include temperature values, temperature differences with respect to ambient, or other suitable parameters with respect to a time of day, day of week, day of month, day of year, etc. Example temperature profiles are described in more detail below with reference to FIGS. 3A and 3B. In certain embodiments, the data preprocessor 302 can also be configured to validate the received target profile (e.g., by verifying data validity) and indicating data errors based on certain preset criteria. In further embodiments, the data preprocessor 102 can be configured to format, segment, initialize, or otherwise prepare the received data for further processing by the control module 134. For instance, the data preprocessor 132 can be configured to receive and convert the sensor data 128 into digital data suitable for the control module 134.

The control module 134 can be configured to generate a control signal 138 based on the target profile 126 and the sensor data 128. In one embodiment, the control module 134 can include a PID routine that uses a value from the target profile 126 as a setpoint and the sensor data 128 as a process variable. Based on the received data, the PID routine can then generate a control variable, such as a discrete signal to turn on the recirculation blower 124 and an analog signal as an energy output percentage for the heating/cooling element 122. In other embodiments, the control module 134 can include a condition routine configured to generate only discrete signals to both the heating/cooling element 122 and the recirculation blower 124. In further embodiments, the control module 134 can also include state machines, cascaded control routines, or other suitable routines in addition to or in lieu of the foregoing example routines.

The output module 136 can be configured to receive the process variable generated by the control module 134, formate the process variable into a control signal 138, and transmit the control signal 138 to the heating/cooling element 122, the recirculation blower 124, and the air curtain unit 112. For instance, the output module 136 can generate a latch command signal to each of the foregoing components to energize until an unlatch signal is received. In other examples, the output module 136 can also generate an analog output signal or other suitable types of output signals.

FIGS. 3A and 3B are examples of temperature profiles 300 and 300′ related to the climate control system of FIG. 1 in accordance with embodiments of the disclosed technology. In particular, FIG. 3A depicts a typical diurnal cycle for an ambient temperature and continuously elevated temperature profile. As shown in FIG. 3A, the test temperature profile generally tracks the ambient temperature profile. FIG. 3B illustrates the condition of elevated diurnal lows and highs. However, mid-cycle temperatures are allowed to match ambient. For some studies, such a cycle can be selected for various reasons, including efficiency, prior knowledge that a target plant is most sensitive to altered highs/lows, and to reduce impacts of air curtain and heating system on exposure to ambient humidity and pestilence. In addition to or in lieu of the profiles shown in FIGS. 3A and 3B, other profiles can be programmed in relation to precipitation/irrigation cycles to explore impacts of elevated (or reduced) temperatures during evaporation phases or during periods of relative drought (e.g., selectable time period for heating to cycle after last precipitation).

FIGS. 4A and 4B are additional examples of the climate control system 100 of FIG. 1 in accordance with embodiments of the disclosed technology. In general, the semi-enclosed structure 104 can be configured to accommodate various crops and study needs, and other form factors can be used to accommodate control, heating, and air curtain components. For example, FIG. 4A depicts an enclosure with one or more sides 401 in a semi-circular prism shape. Side material can be selected to partially or fully block lateral wind flow and can have any opacity. Partial to fully opaque materials can block direct sunlight similar to interior crops planted in a field. Translucent or transparent materials can be selected to allow greater sun exposure with awareness of potential lens effects of curved or flexible materials.

Daytime passive heating through sides 401 can also augment and increase efficiency of the conditioning assembly 122 (FIG. 1). In some applications, sides 401 can be made from multiple materials, such as adding a flexible baffle (e.g., vinyl canvas) at bottom of one or more sides 401 in order to facilitate conformity and relative seal to uneven ground. The sides 401 can be hinged together or fastened by various mechanical means, including quick-release latches to ease assembly, transport, and disassembly. Openings 402 and/or slots 403 can be formed in the sides 401 to accommodate heating/cooling and an air curtain. As shown in FIG. 4A, openings 402 are spaced out on one flat side 401 for efficient recirculation and conditioning of air. Slots 403 can be fitted in the sides 401 with or without embedded nozzle shapes to direct air curtain. Alternately, the air curtain unit 112 (FIG. 1) can be designed to fit over the top lip of the side 401 such that no slots 403 are needed so long as the climate control system 400 achieves highly laminar flow.

FIG. 4B depicts external components mounted on one side 401 of the semi-enclosed structure in FIG. 4A. An air curtain unit 404 can be mounted over or adjacent to slots 403 or over top of side 401 as described above to achieve substantially laminar flow across top of the structure. Air intake holes or slots are depicted on the side of air curtain unit 404 but can be designed into the underside/lower surface to reduce dust intrusion and grime buildup. A heating assembly 405 can include intake and outflow ducting 406 to attach to openings 402 in FIG. 4A and facilitate recirculation and reheating (or re-cooling) of air. Similarly, a climate controller 407 can be affixed to the side 401, be embedded with one of the other assemblies, or be fully and/or partially connected remotely with a separate user interface (e.g., smart phone) and attached power supply, processor, relay, memory/data storage, and communication components (e.g., Wi-Fi).

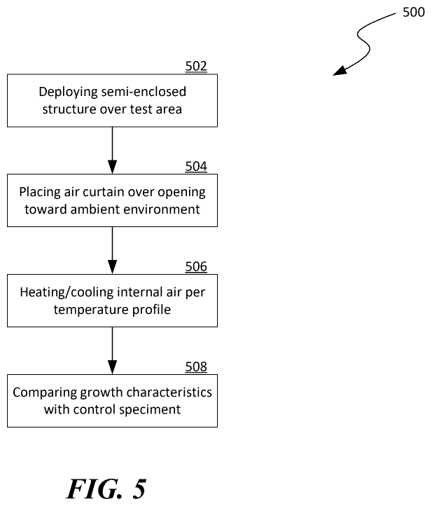

FIG. 5 is a flow diagram illustrating an example process 500 of using the climate control system of FIG. 1 in accordance with embodiments of the disclosed technology. Though embodiments of the process 500 are described below in the context of the climate control system 100 of FIG. 1, in other embodiments, the process 500 can also be implemented in other systems with similar or different components.

As shown in FIG. 5, the process 500 can include deploying a semi-enclosed structure 104 (FIG. 1) over a test area to partially enclose one or more test specimens 102a (FIG. 1) at stage 502. The semi-enclosed structure 104 has a first opening 107a proximate to the test specimens 102a and a second opening 107b exposed to the ambient air. The process 500 can then proceed to placing an air curtain 114 (FIG. 1) across the second opening 107b of the semi-enclosed structure 104 at stage 504. The air curtain 114 can thus limit or prevent thermal interactions between air in the internal space 109 (FIG. 1) of the semi-enclosed structure 104 and the ambient air.

The process 500 can then include heating/cooling the air in the internal space 109 of the semi-enclosed structure based on a target temperature profile at stage 506. In one embodiment, heated air is provided to the internal space 109 of the semi-enclosed structure 104 until the temperature of the internal space 109 is at or within a threshold of a setpoint selected based on the target temperature profile. In other embodiments, the temperature of the heated air is adjusted to maintain the temperature of the internal space 109 at or within a threshold of the setpoint. In further embodiments, step control or other suitable control schemes can also be applied to adjust and/or maintain the temperature of the internal space 109. The process 500 can then include comparing growth characteristics of the test specimens with control specimens outside of the semi-enclosed structure 104 at stage 508. As such, impacts of abnormal environmental conditions, such as high temperatures on plant growth can be studied while holding other environmental variables generally constant in an energy efficient manner.

From the foregoing, it will be appreciated that specific embodiments of the technology have been described herein for purposes of illustration, but that various modifications may be made without deviating from the disclosure. In addition, many of the elements of one embodiment may be combined with other embodiments in addition to or in lieu of the elements of the other embodiments. Accordingly, the disclosure is not limited except as by the appended claims.

I/we claim:

1. A climate control system for an open-air field, comprising:
a semi-enclosed structure having one or more sidewalls surrounding an internal space extending between a first opening and second opening opposite the first opening, wherein the one or more sidewalls include a first end proximate the first opening and a second end proximate the second opening, the first end being configured to be at least partially planted into the soil in the test area while the second opening is configured to be exposed to ambient air;
an air curtain unit operatively coupled to the semi-enclosed structure, the air curtain unit being configured to selectively form an air curtain across the second opening of the semi-enclosed structure; and
a conditioning assembly in fluid communication with the internal space of the semi-enclosed structure, the conditioning assembly being configured to raise or lower a temperature in the internal space of the semi-enclosed structure.

2. The climate control system of claim 1 wherein the one or more sidewalls include two pairs of opposing panels coupled to one another to form a generally rectangular prism.

3. The climate control system of claim 1 wherein the one or more sidewalls include two pairs of opposing panels coupled to one another to form a generally rectangular prism, and wherein the air curtain unit includes one or more fans, mounted on one of the panels and configured to generate an air stream toward another one of the panels opposite the one of the panels.

4. The climate control system of claim 1 wherein the one or more sidewalls include a first panel and a second panel opposite the first panel, the first panel having a slit in fluid communication with the internal space of the semi-enclosed structure, and wherein the air curtain unit includes one or more fans configured to provide an air stream toward the second panel via the slit of the first panel.

5. The climate control system of claim 1 wherein the one or more sidewalls include a first panel coupled to a second panel of a generally semi-circular shape, the first panel having a slit in fluid communication with the internal space of the semi-enclosed structure, and wherein the air curtain unit includes one or more fans configured to provide an air stream toward the second panel via the slit of the first panel.

6. The climate control system of claim 1, further comprising a climate controller operatively coupled to the conditioning assembly and the air curtain unit, wherein the climate controller is configured to selectively maintain a continuously or intermittently raised or lowered temperature within the internal space of the semi-enclosed structure as compared to a temperature of the ambient air while the air curtain limits or prevents thermal interaction between air in the internal space of the semi-enclosed structure with the ambient air.

7. A method of climate control in an open-air field, comprising:
placing a semi-enclosed structure over a test area growing a test specimen of a crop in the open-air field also having a control specimen outside of the semi-enclosed structure, the semi-enclosed structure having one or more sidewalls surrounding an internal space extending between a first opening and second opening opposite the first opening;
exposing both the test specimen within the semi-enclosed structure and the control specimen outside of the semi-enclosed structure to substantially the same sunlight, precipitation, and/or pestilence conditions for a test period;
during the test period, maintaining a temperature difference between air in the internal space of the semi-enclosed structure and the ambient air while using an air curtain across the second opening of the semi-enclosed structure to limit or prevent thermal interactions between the air in the internal space of the semi-enclosed structure and the ambient air; and
subsequently, determining impact of the temperature difference on growth of the crop by comparing a growth characteristic between the test specimen and the control specimen.

8. The method of claim 7 wherein maintaining the temperature difference includes maintaining one of a continuously elevated temperature from the ambient temperature, a continuously lower temperature from the ambient temperature, an intermittently elevated temperature from the ambient temperature, or an intermittently reduced temperature from the ambient temperature.

9. The method of claim 7 wherein maintaining the temperature difference includes maintaining a continuously elevated temperature in the range of about 0° C. to about 10° C. from the ambient temperature.

10. The method of claim 7 wherein the one or more sidewalls include a first end proximate the first opening and a second end proximate the second opening, and wherein placing the semi-enclosed structure includes at least partially planting the first end into soil in the test area while the second opening is exposed to the ambient air.

11. The method of claim 7 wherein the one or more sidewalls include a first panel and a second panel opposite the first panel, the first panel having one or more fans, and wherein the method further includes generating an air stream toward the second panel opposite the first panel to form the air curtain.

12. The method of claim 7 wherein the one or more sidewalls include a first panel and a second panel opposite the first panel, the first panel having a slit in fluid communication with the internal space of the semi-enclosed structure, and wherein the method further includes providing an air stream toward the second panel via the slit on the first panel to form the air curtain.

13. The method of claim 7 wherein the one or more sidewalls include a first panel coupled to a second panel of a generally semi-circular shape, the first panel having a slit in fluid communication with the internal space of the semi-enclosed structure, and wherein the method further includes providing an air stream toward the second panel via the slit on the first panel to form the air curtain.

14. A method of climate control in an open-air field, comprising:
exposing a test specimen of a crop growing in the open-air field to substantially the same sunlight, precipitation, and/or pestilence conditions as a control specimen in the same open-air field for a test period, the test specimen being at least partially enclosed by a structure while the control specimen being outside of the structure, the structure having one or more sidewalls surrounding an internal space containing the test specimen and extending between a first opening toward soil of the open-air field and second opening opposite the first opening;
during the test period, maintaining a test temperature profile in the internal space of the structure while placing an air curtain across the second opening of the structure to limit or prevent thermal interactions between the internal space of the structure and the ambient air, the test temperature profile being different than a temperature profile of the ambient air; and
subsequently, determining impact of the maintained test temperature profile on growth of the crop by comparing a growth characteristic between the test specimen and the control specimen of the crop.

15. The method of claim 14 wherein maintaining the test temperature profile includes maintaining one of a continuously elevated temperature from an ambient temperature, a continuously lower temperature from the ambient temperature, an intermittently elevated temperature from the ambient temperature, or an intermittently reduced temperature from the ambient temperature.

16. The method of claim 14 wherein maintaining the test temperature profile includes maintaining a continuously elevated temperature in the range of about 0° C. to about 10° C. from the ambient temperature.

17. The method of claim 14 wherein the one or more sidewalls include a first end proximate the first opening and a second end proximate the second opening, and wherein the method further includes at least partially planting the first end of the one or more sidewalls into the soil while the second opening is exposed to the ambient air.

18. The method of claim 14 wherein the one or more sidewalls include a first panel and a second panel opposite the first panel, the first panel having one or more fans, and wherein the method further includes generating an air stream toward the second panel opposite the first panel to form the air curtain.

19. The method of claim 14 wherein the one or more sidewalls include a first panel and a second panel opposite the first panel, the first panel having a slit in fluid communication with the internal space of the structure, and wherein the method further includes providing an air stream toward the second panel via the slit on the first panel to form the air curtain.

20. The method of claim 14 wherein the one or more sidewalls include a first panel coupled to a second panel of a generally semi-circular shape, the first panel having a slit in fluid communication with the internal space of the structure, and wherein the method further includes providing an air stream toward the second panel via the slit on the first panel to form the air curtain.
